(19) United States
(12) Patent Application Publication
(10) Pub. No.: US 2010/0269663 A1
(43) Pub. Date: Oct. 28, 2010

(54) LONGITUDINAL CUTTING MACHINE

(76) Inventor: Len Ivel, Leicester, MA (US)

Correspondence Address: ROBERT W. BECKER & ASSOCIATES, 707 HIGHWAY 333, SUITE B, TIJERAS, NM, 87059-7507, US

(21) Appl. No.: 12/429,037

(22) Filed: Apr. 23, 2009

(51) Int. Cl. B26D 1/24; B26D 1/14

(52) U.S. Cl. 83/495; 83/508.2

(57) ABSTRACT

A longitudinal cutting machine having a bottom knife mounting plate disposed on the motor shaft of a motor, wherein the mounting plate is rotated by the motor shaft. A bottom knife is mounted on the mounting plate and cooperates with a top knife. At least one air bearing is mounted on an air bearing mounting plate, and is adapted to provide a gap between the air bearing and the bottom knife mounting plate.

### BACKGROUND OF THE INVENTION

The present invention relates to a longitudinal cutting machine, especially for use in slitting systems, for example for shear cutting of aluminum sheets or coils, extrusion form lines, non-wovens, and any other applications where, in particular, motorized bottom knives are used.

Conventional longitudinal cutting machines having motorized bottom knives for slitting systems operate over a wide range of speeds, and experience varying loads in both the axial and the radial directions. Although it is usually possible to compensate for variations in radial load, the variations in the axial loads that can occur during applications requiring extreme slit width accuracies cause a lack of precision and poor edge qualities.

It is therefore an object of the present invention to overcome the aforementioned problems with a longitudinal cutting machine that provides the required axial stiffness.

### BRIEF DESCRIPTION OF THE DRAWINGS

This object, and other object and advantages of the present application, will appear more clearly from the following specification in conjunction with the accompanying schematic drawings, in which:

FIG. 1 is a partial cross-sectional view of a support mechanism for a bottom knife of a longitudinal cutting machine of the present application;

FIG. 2 shows an arrangement of the air bearings for the support mechanism shown in FIG. 1;

FIGS. 3 and 4 are views of a support mechanism for a top knife of a longitudinal cutting machine of the present application;

FIGS. 5 and 6 are views showing the air bearings in combination with a radial roller bearing; and

FIGS. 7 and 8 are views showing the air bearings in combination with pockets or recesses to enhance the rotational movement of the top knife.

### SUMMARY OF THE INVENTION

The longitudinal cutting machine of the present application comprises a motor; a bottom knife mounting plate disposed on a motor shaft of the motor, wherein the bottom knife mounting plate is adapted to be rotated by the motor shaft; a bottom knife mounted on the bottom knife mounting plate, wherein the bottom knife is adapted to cooperate with a top knife; an air bearing mounting plate; and at least one air bearing mounted on the air bearing mounting plate, wherein the at least one air bearing is adapted to provide an air gap between the at least one air bearing and the bottom knife mounting plate.

The inventive approach of providing at least one air bearing significantly enhances axial stiffness of the motor and the bottom knife, providing the necessary axial support with zero static friction, zero wear, smoother rotation, and higher speed capability than is possible with the known conventional roller bearings.

### DESCRIPTION OF SPECIFIC EMBODIMENTS

Referring now to the drawings in detail, illustrated are details of the longitudinal cutting machine of the present application, and especially with respect to the support mechanism for the knife holders of such a longitudinal cutting machine.

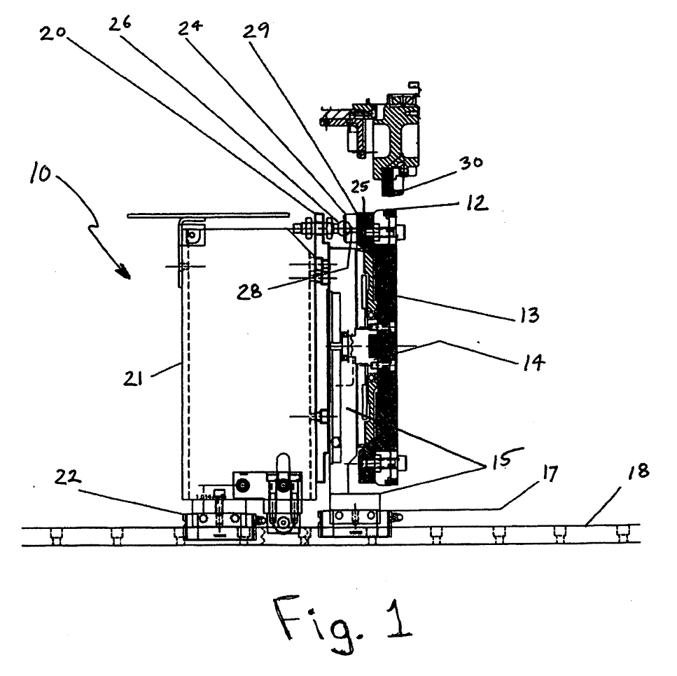

The longitudinal cutting machine of the present application will initially be described in conjunction with the support mechanism of the bottom knife of such a longitudinal cutting machine. In particular, in the embodiment illustrated in FIG. 1, a support mechanism, which is designated generally by the reference numeral 10, is illustrated for the bottom knife 12 of a longitudinal cutting machine pursuant to the present application. The bottom knife 12 is mounted on a bottom knife mounting plate 13. In order to be able to rotate the bottom knife 12 for slitting operations, the bottom knife mounting plate 13 is mounted on the motor shaft 14 of the bottom knife motor 15. The motor 15 can be mounted on linear bearings 17 to allow movement of the motor 15 along linear rails 18.

To overcome wobbling of the bottom knife 12, and to thereby overcome the lack of precision and poor edge qualities that result with heretofore known bottom knife systems, an air bearing mounting plate 20 is mounted on a support bracket 21. Similar to the bottom knife motor 15, the support bracket 21 is mounted on bearings 22 that in turn are mounted on the same linear rails 18 as are the linear bearings 17 for the motor 15. The air bearing mounting plate 20 can also be mounted to the motor 15, thereby being sandwiched between the support bracket 21 and the motor 15. As a result, the motor 15 and the support bracket 21 can be positioned as a unit by movement thereof along the linear rails 18.

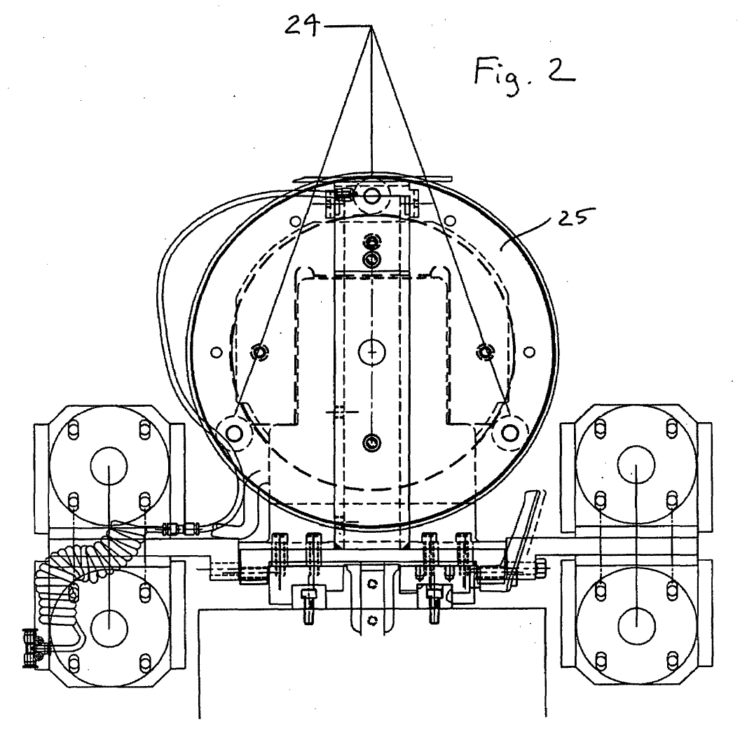

At least one air bearing 24, and preferably at least three air bearings 24, are mounted on the air bearing mounting plate 20. An arrangement showing three air bearings 24, which are disposed 120° apart, can be seen in FIG. 2. The air bearings 24 are disposed adjacent to the bottom knife mounting plate 13. In the illustrated embodiment, the air bearings 24 are disposed adjacent to an annular projection 25 of the bottom knife mounting plate 13. In particular, support studs or posts 26 are provided that are mounted on the mounting plate 20 for holding the air bearings 24 against the annular projection 25 of the bottom knife mounting plate 13. As can be seen in FIG. 1, each of the air bearings 24 has a spherical recess that mates with a correspondingly shaped surface of its post 26. In particular, the air bearing 24 sits loosely on the post 26 and is prevented from falling off of the post 26 by an appropriate setting of the gap 29 between the air bearing 24 and the bottom knife mounting plate 13.

During operation of the longitudinal cutting machine, pressurized air is fed into an air inlet 28 that is provided on each of the air bearings 24. When sufficient pressurized air is fed to the air bearings 24, an air gap 29 is formed between the air bearings 24 and the mounting plate 13, i.e. the annular projection 25 thereof. The support posts 26 provide means for adjusting the air gap 29, the size of which can be set by either screwing the threaded support posts 26 toward the mounting plate 13 or away from the mounting plate. The air gap 29 is preferably adjusted to a minimum distance that will provide for maximum axial stiffness with zero contact between the air bearings 24 and the mounting plate 13 during rotation of the motor 15. The top knife 30 is adapted to be moved toward or away from the bottom knife 12 to achieve the distance required between the knives for the material that needs to be cut or slit.

As mentioned above, FIG. 2 shows three air bearings 24 that are spaced 120° apart. In the illustrated embodiment, the air bearings 24 are disposed across from the annular projection 25 of the bottom knife mounting plate 13, and provide an even support for the rotating mounting plate 13. As can be seen from FIG. 2, the uppermost air bearing 24 is aligned with the vertical center line of the bottom knife mounting plate 13, since this is where cutting or slitting takes place and lateral support to resist cutting forces and deflections is most critical here. It should be noted that the present invention is not limited to three air bearings that are spaced 120° apart, or even to three air bearings.

Both the bottom knife 12 and the top knife 30 must rotate to effect a cutting or slitting operation. The top knife is therefore also rotatably mounted, but need not have its own drive means to effect rotation. In such a case, the contact pressure from the bottom knife 12 causes rotation of the top knife 30. However, both the bottom and top knives can be provided with their own drive means. This makes it possible to adjust the speed of either the top or bottom knife to optimize their speed for the material that is being cut.

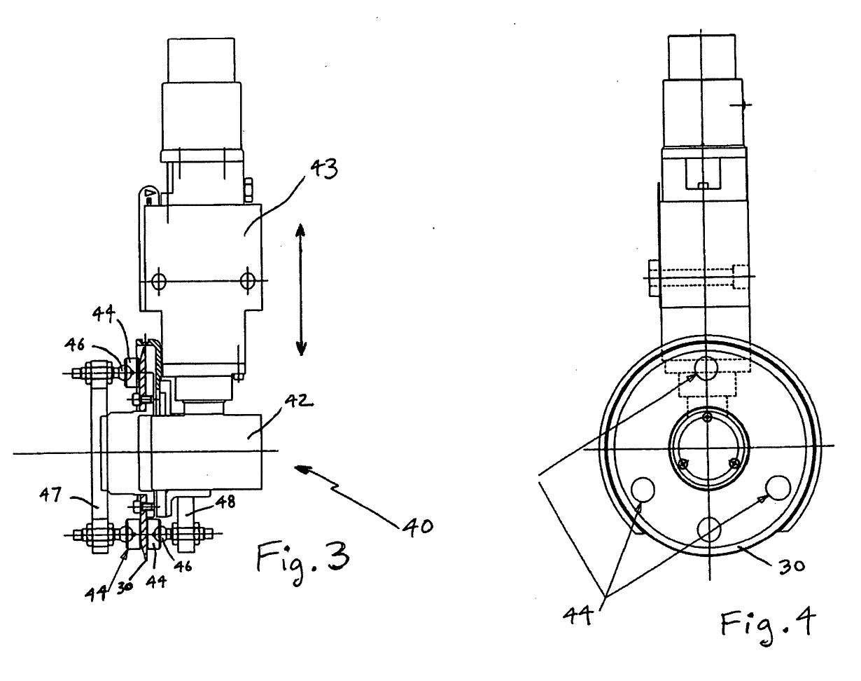

In addition, the top knife 30 can also be provided with an air bearing support mechanism. Exemplary embodiments of such a support mechanism of the top knife of the longitudinal cutting machine of the present application are shown in FIGS. 3 and 4, and are designated generally by the reference numeral 40. The top knife 30 is either rotatably mounted on a shaft 42, or the shaft can be a motor shaft, rotation of which effects rotation of the top knife 30.

The top knife 30 can be moved toward and away from the bottom knife 12 in order to appropriately set the distance between the two knives. This movement is effected by the generally indicated mechanism 43, the operation of which is known to those of skill in the art. It should also be noted that the top knife 30 can be moved in a direction parallel to the axis of the shaft 42, for example in a manner similar to that discussed in connection with the lateral movement of the bottom knife 12.

As shown in FIGS. 3 and 4, several air bearings 44 are provided for the top knife 30. These air bearings 44 are comparable in construction to the air bearings 24 described in conjunction with the bottom knife arrangement of FIGS. 1 and 2. Again, posts 46 are provided for supporting the air bearings 44 via mating spherical surfaces. The studs or posts 46 are threadably mounted on support means 47 and 48. In the embodiment illustrated in FIG. 3, air bearings 44 are disposed on both sides of the top knife 30.

As can be seen from FIG. 3, disposed at the lower end of the knife 30 are two air bearings 44 that are disposed across from one another, on opposite sides of the circular knife or blade, and supporting the knife between them. In this connection, the left one of the two air bearings 44, as is also true for the air bearing 44 disposed at the upper end, serve for an appropriate support of the knife 30. On the right side, during a cutting or slitting operation the tip of the knife 30 experiences a counter force, from the bottom knife 12, that acts toward the left. Situations can thereby occur in which the bottom knife does not rotate uniformly true; rather, lateral oscillations can occur that cause the bottom knife to move toward the right, in other words, away from the top knife 30. In such case, the top knife 30 would try to follow the movement of the bottom knife 12, whereby pursuant to the present invention this movement of the top knife 30 toward the right would be supported by the second or right air bearing 44 that is disposed across from the left air bearing.

Another possible arrangement for the air bearings 44 is shown in FIG. 4. Three air bearings 44 are shown spaced 120° apart to provide even support around the rotating top knife 30. A fourth air bearing 44 can be disposed at the bottom aligned with the vertical center line of the top knife 30, and in particular across from the air bearing 44 disposed on the opposite side of the top knife 30. As was the case with the air bearings 24 for the bottom knife 12, also with regard to the support mechanism 40 for the top knife 30, it is not necessary that the air bearings 44 disposed on one side of the knife 30 be spaced 120° apart, nor is the number of air bearings limited to three.

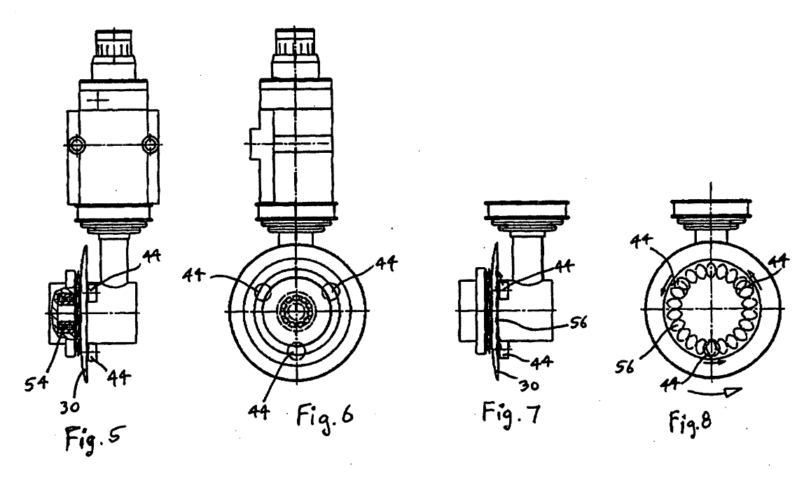

Similar to the situation illustrated in FIG. 1 for the bottom knife 12, the axially operating air bearings 44 can also be combined with conventional bearings to thereby make it possible to provide a separation of the bearing forces that occur into axial forces and into radial forces. For example, the side view of FIG. 5 and the front view of FIG. 6 show three axially operating air bearings 44 in conjunction with a centrally disposed roller bearing 54, which takes over the radial bearing forces. Thus, the embodiment illustrated in FIG. 5 and 6 shows the common arrangement of air bearings and roller bearings, and the division of the respectively acting bearing forces into the axial bearing forces received by the air bearings and the radial bearing forces received by the roller bearing.

A further embodiment of the present invention provides for the utilization of the air that is discharged by the air bearings in the direction of the respective knives in order to bring about a further torque or moment of rotation in the direction of rotation of the knife. For this purpose, it is then necessary, on that side that faces the pertaining air bearings of the knife, to mount structures that can guide the air, such as vanes, pockets or recesses, or the like, in order to convert the axial oncoming air flow exiting the air bearings into a rotation of the knife. For example, the side view of FIG. 7 and the front view of FIG. 8 again show three axially operating air bearings 44, but in addition thereto pockets or recesses 56 disposed on the back side of the knife that faces the air bearings. From the oncoming air flow from the air bearings 44, the pockets or recesses 56 apply a torque onto the knife or the knife support mechanism. Thus, the air bearings additionally enhance the rotational movement of the knife. In this connection, the torque applied by the air bearings is so slight that no speed-regulating device is required, and merely the bearing friction and frictional loss of the friction-gear-like knife contact of the illustrated top knife with a non-illustrated bottom knife is compensated for.

The present invention is, of course, in no way restricted to the specific disclosure of the specification and drawings, but also encompasses any modifications within the scope of the appended claims.

What I claim is:

1. A longitudinal cutting machine, comprising:
a motor;
a bottom knife mounting plate disposed on a motor shaft of said motor, wherein said bottom knife mounting plate is adapted to be rotated by said motor shaft;
a bottom knife mounted on said bottom knife mounting plate, wherein said bottom knife is adapted to cooperate with a top knife (30);
an air bearing mounting plate; and
at least one air bearing mounted on said air bearing mounting plate, wherein said at least one air bearing is adapted to provide an air gap between said at least one air bearing and said bottom knife mounting plate.

2. A longitudinal cutting machine according to claim 1, which further comprises means for adjusting said air gap.

3. A longitudinal cutting machine according to claim 2, wherein said means for adjusting said air gap comprises a post that is displaceably mounted on said air bearing mounting plate so as to be displaceable toward and away from said bottom knife mounting plate, and wherein said air bearing is seated on said post.

4. A longitudinal cutting machine according claim 3, wherein said air bearing and said post are provided with correspondingly shaped mating seating surfaces.

5. A longitudinal cutting machine according claim 1, which further includes a support bracket, wherein said air bearing mounting plate is mounted on said support bracket.

6. A longitudinal cutting machine according to claim 1, which further includes a support bracket, wherein said motor is mounted on said support bracket and said air bearing mounting plate is disposed on said motor.

7. A longitudinal cutting machine according to claim 1, wherein three air bearings are disposed 120° apart on said air bearing mounting plate across from a periphery of said bottom knife mounting plate.

8. A longitudinal cutting machine according to claim 7, wherein said bottom knife mounting plate is provided with an annular projection that faces said air bearing mounting plate, and wherein said air bearings are disposed across from said annular projection.

9. A longitudinal cutting machine according to claim 1, wherein said top knife is rotatably mounted.

10. A longitudinal cutting machine according to claim 9, which further includes air bearing support means that are stationary relative to said top knife.

11. A longitudinal cutting machine according to claim 10, which includes at least one further air bearing mounted on said air bearing support means.

12. A longitudinal cutting machine according to claim 11, which includes at least two further air bearings disposed on opposite sides of said top knife.

13. A longitudinal cutting machine according to claim 9, wherein said top knife is disposed on a shaft.

14. A longitudinal cutting machine according to claim 13, wherein said shaft is a motor shaft.

15. A longitudinal cutting machine according to claim 1, wherein said motor, with said bottom knife mounting plate disposed thereon, is displaceable in the direction of an axis of said motor shaft.

16. A longitudinal cutting machine according to claim 15, wherein said motor is mounted on linear rails.

17. A longitudinal cutting machine according to claim 11, wherein at least one pair of air bearings is provided, and wherein the air bearings of this pair are disposed on opposite sides of said top knife.

18. A longitudinal cutting machine according to claim 11, wherein at least one of said bottom knife and said top knife is supported by a roller bearing.

19. A longitudinal cutting machine according to claim 11, wherein pockets or recesses are disposed on a side of said top knife that faces said at least one further air bearing for directing air from said air bearing onto said side of said top knife.
